(19) United States
(12) Patent Application Publication
(10) Pub. No.: US 2011/0302318 A1
(43) Pub. Date: Dec. 8, 2011

(54) ANONYMOUS RE-STREAMING OF MEDIA ITEM OF CONTENT

(76) Inventor: Ari Birger, Palo Alto, CA (US)

(21) Appl. No.: 13/152,172

(22) Filed: Jun. 2, 2011

Related U.S. Application Data
(60) Provisional application No. 61/351,521, filed on Jun. 4, 2010.

(51) Int. Cl. G06F 15/16

(52) U.S. Cl. 709/231

(57) ABSTRACT

Particular embodiments include a method of operating a processing system, an apparatus, logic encoded in one or more computer-readable tangible medium to carry out a method, and a tangible computer-readable storage medium configured with instructions that when executed cause carrying out the method. The method comprising: (a) as a result of a request for a stream of a first item of content, receiving the stream of the first item of content and providing an indication that a foreign stream is being received; (b) unless there is an indication that a foreign stream is being received, streaming a default item of content to a local media player; and (c) in the case there is an indication that a foreign stream is being received, re-streaming the received stream of the first item of content, such that local media player renders the requested stream of the first item of content. In some versions, the re-streamed first item of content mimics the default item of content.

### RELATED PATENT APPLICATIONS

This application claims benefit of priority of and is a conversion of U.S. Provisional Patent Application No. 61/351,521 filed Jun. 4, 2010 to inventor Birger, and titled ANYNYMOUS RE-STREAMING OF MEDIA ITEM OF CONTENT, the contents of which are incorporated herein by reference.

### FIELD OF THE INVENTION

The present disclosure relates generally to playback of media item of content in a local network.

### BACKGROUND

Local networks such as home media networks are known. One example, and by no means the only example, is a UPnP architecture. In such architecture, three distinct entities are involved: 1) a control point, 2) a source of the media item of content, called the “media server”, and a sink for the item of content, called the “media renderer” or “media player.”

There are many outside sources of item of content, including interactive item of content. The World Wide Web (“Web”) is one, but by no means the only example. Many other examples are available. Some of the item of content so sourced may not be suitable for consumption by everyone, and furthermore, a viewer may not want it known that she is viewing such item of content. Thus, there is a need for privacy.

A large screen device such as a television screen is typically a communal device accessible to and viewable at the same time by many people. It is often difficult to achieve privacy on such a communal device. For example, there may be a record of what was viewed, anyone is able to turn the device on and view item of content, and so forth. A small device such as a personal computer (PC) or mobile device (a smartphone such as an iPhone, a mobile device such as an iPad, a laptop computer, etc.), all referred to herein as a personal device, on the other hand can provide an adequate level of privacy. However, the display on such a device is typically small.

There is effort these days to bring private item of content on to communal devices such as a large screen television monitor.

### BRIEF DESCRIPTION OF THE DRAWINGS

FIG. 1 shows an example network environment that includes an embodiment of the present invention.

FIG. 2 shows example flowcharts of example operations of one embodiment of the invention.

FIG. 3 shows a highly simplified block diagram of an example of the processing system 103 that includes aspects of the present invention.

### DESCRIPTION OF EXAMPLE EMBODIMENTS

### Overview

Embodiments of the present invention include a method, an apparatus, logic encoded in one or more computer-readable tangible medium to carry out a method, and a tangible computer-readable storage medium configured with instructions that when executed cause carrying out the method. In some versions, the method includes re-streaming an item of content to mimic another item of content.

Particular embodiments include a method of operating a processing system, the method comprising: (a) as a result of a request for a stream of a first item of content, receiving the stream of the first item of content and providing an indication that a foreign stream is being received; (b) unless there is an indication that a foreign stream is being received, streaming a default item of content to a local media player; and (c) in the case there is an indication that a foreign stream is being received, re-streaming the received stream of the first item of content, such that local media player renders the requested stream of the first item of content.

Particular embodiments include a data processing apparatus comprising: (a) an external network media player coupled to a first source of content, the first source of content including a first item of content, the external network media player configured as a result of receiving a request from a user interface to receive a stream of the first item of content from the first source of content; (b) a re-streamer coupled to the external network media player and configured to receive a stream of a first item of content from the external network media player and re-stream the a first item of content to a second stream of a second item of content that includes the content of the stream of the first item of content; and (c) a local network media server coupled to the re-streamer and configured in the case there is not an indication that a foreign stream is being received to stream a default item of content to a local media player, and in the case there is an indication that a foreign stream is being received, to accept the second stream of the second item of content, such that in the case there is the indication that a foreign stream is being received, the second stream is streamed to the local server, the second stream including the content of the stream of the first item of content.

Particular embodiments include a tangible computer readable storage medium configured with instructions that when executed by one or more processors of a operating a processing system, cause a method to be carried out, the method comprising: (a) as a result of a request for a stream of a first item of content, receiving the stream of the first item of content and providing an indication that a foreign stream is being received; (b) unless there is an indication that a foreign stream is being received, streaming a default item of content to a local media player; and (c) in the case there is an indication that a foreign stream is being received, re-streaming the received stream of the first item of content, such that local media player renders the requested stream of the first item of content.

In some embodiments, the indication that a foreign stream is being received is implicit. In other embodiments, the indication that a foreign stream is being received is explicit and includes a settable flag being set.

In some embodiments, the first item of content is streamed by a server that is coupled to the processing system by a network.

In some embodiment, the re-streaming of the first item of content outputs a stream that mimics the default item of content, and includes the content of the first item of content.

In some embodiments, each of the stream of the first item of content and the stream of the default item of content includes a respective stream property object, optionally a respective more information object, and respective content packets. The re-streaming creates a stream whose content packets render the same content as the stream of the first item of content, and the stream property object and the more information object are created such that the re-streamed stream appears to the local media player to be a stream of the default item of content, even though when rendered on the local media player, the rendering is of the first item of content.

In some embodiments, the content stream of the first item of content is in a first coded format and the stream of the default item of content is in a second different coded format, and the re-streaming includes transcoding from the first format to the second coded format.

In some embodiments, the receiving as a result of the request is from a server via an external network to which the processing system is coupled. As an example, via the external network includes via the Internet.

In some embodiments, the receiving a result of the request is from a storage subsystem included in the processing system.

In some embodiments, as a result of receiving the request, there is undergoing of one or both authorization and authentication such that the receiving of the stream of the first item of content is only after success of the one or both of authorization and authentication.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### Embodiment 1

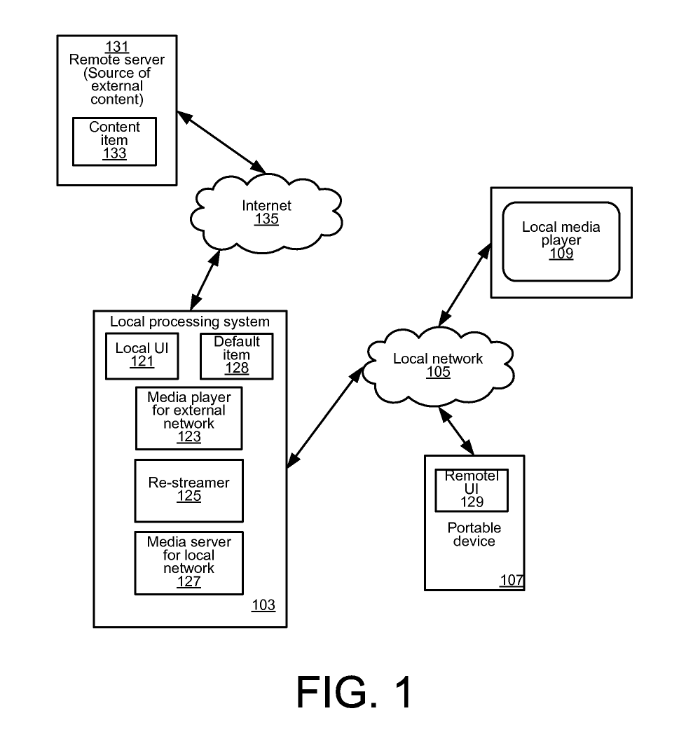

FIG. 1 shows an example network environment that includes an embodiment of the present invention. One or more remote servers 131 are each a source of items of content. One such item of content file is shown as 133 in FIG. 1. This is referred to herein as the external item of content, and also the “foreign” item of content, wherein foreign implies different than what is normally played back. It does not mean in a non-local language, or from a different country. A local network 105, e.g., a home network has coupled to it a local processing system 103 and at least one device that can act as a local playback device. This is shown as local media player 109. The local playback device 109 may be, for example, a game device such as a Sony PS3, a Microsoft Xbox, etc., a set-top box, or a network connected DVD player, or a network connectable TV, e.g., a TV conforming to device conforming to Digital Living Network Alliance (DLNA), any other DNLA playback device, and so forth. In embodiments that conform to a UPnP architecture, this is a media player. The local network and its elements is coupled to an external network 135, which is a wide area network, e.g., the Internet, via the local processing system 103. While a single external network 135 is shown, this may be comprised of more than one network, e.g., this might include the Internet 135, a 3G network, a 4G network, a cable distribution network, a fiber network for distributing media item of content, and so forth.

The one or more remote more remote servers 131 can include one or more of a server coupled to the Internet, a cable headend, a source of multimedia games, and so forth.

The local processing system can be one computer or several interconnected devices, some of which include a computer, e.g., devices that are connected by the local network 135. For convenience, the processing system is shown as a single box 103. The local processing system 103 includes one or more processors, and one or more storage devices. The one or more storage devices form a storage subsystem. For purposes of description the storage subsystem includes memory, and one or more other types of storage devices.

Elements of one embodiment of the invention are shown as functional blocks in processing system 103, and may be implemented by executing instructions on at least one of the one or more processors of processing system 103, such instructions provided in the form of stored instructions in a tangible storage medium, e.g., in the one or more storage elements of 103. Alternately, the elements, or parts thereof may be in the form of special purpose hardware.

By a stream is meant an item of content file that is provided as a media stream. The invention is not limited to any particular form of streaming or any particular type of item of content, and can be implemented using one or many stream forms. The invention therefore is applicable to audiovisual item of content, to audio item of content, to newer forms of media such s three-dimensional video, to interactive item of content as in games and other forms, and so forth.

In the UPnP context, each media player can discover one or more media servers that are part of the UPnP environment. One feature of the invention is a local media server 127 for the local network 105 that serves a particular stream. In one particular embodiment, the particular stream is the one and only stream served by the local media server 127. That is, in the UPnP example, the local server 127 appears as a media server 127 to the local media player 109 and serves a particular stream. The local media player can activate consuming the particular stream, in which case the particular stream is streamed to the media player 109 by the local media server 127. In one embodiment, in the absence of any other instruction, the particular stream from the local server 127 is a default stream, e.g., a stream of a default item of content 128 stored in the one or more storage subsystem of the processing system 103. When a user selects the local network media server 127 for playback on the local media player 109, and selects the particular stream, in the absence of any other instruction to the local processing system, the media server for local networks 127 streams the default item of content 128 to the local media player 109.

It should be noted that by “foreign item” here is meant an item of content that is to be re-streamed to play back on the local media player 109 such that the local media player is unaware that it is playing back other than the other that the default item of content 128. That is, the re-streaming generates output that mimics the default item of content 128, but is actually the item of content 133.

The external network media player 123 of the local processing system 103 is controlled by a user interface. In some configuration, the local processing system 103 includes a local user interface 121 and the processing system is configured such that the local user interface can act as a control point for the external network media player 123, e.g., the external network media player 123 is configured to be controllable by the local user interface 121. In some embodiments, in addition, a remote device such as a portable device 107 is included, and in this example, is shown coupled to the local processing system via the local network 105. In some embodiments that include the portable device 107, the portable device includes a remote user interface 129 that can act as a control point to the external network media player, e.g., the external network media player 123 is configured to be controllable by the remote user interface 129.

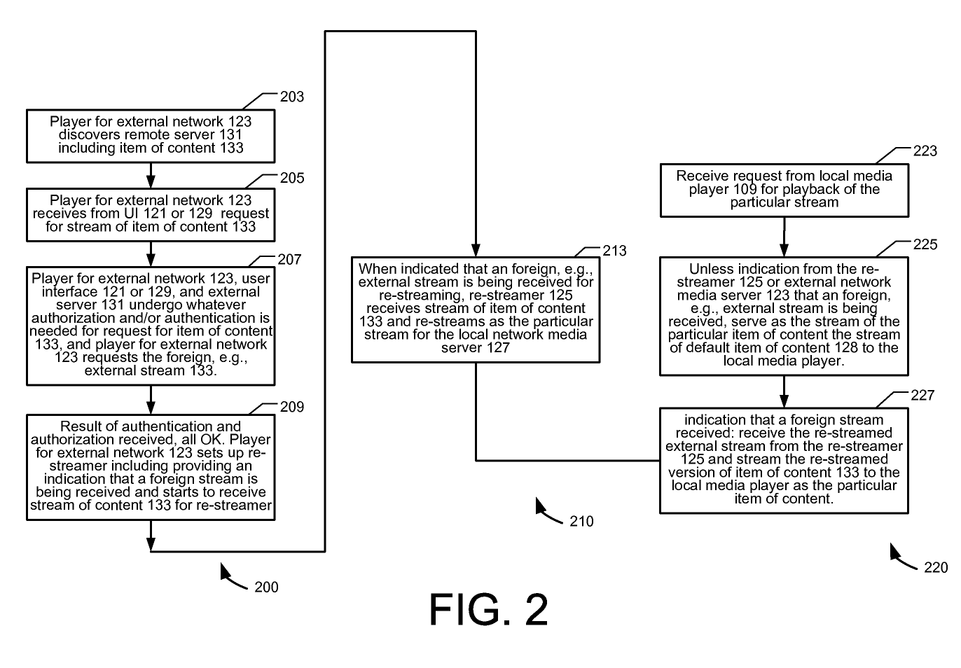

FIG. 2 shows example flowcharts of example operations of one embodiment of the invention. Recall, when a user selects the local network media server 127 for playback on the local media player 109, and selects the particular stream, in the absence of any other instruction to the local processing system, the media server for local networks 127 streams the default item of content 128 to the local media player 109.

FIG. 2 shows operation according to some features of the present invention. The operations at the player for external network—the external network media player 123—are indicated by the flowchart portion 200, the operations at the re-streamer are indicated by the flowchart portion 210, and the operation at the server for the local network—the local network server 127 are indicated by the flowchart portion 220. This flowchart is one example of how the operations may be configured, and variations would be clear to those skilled in the art.

A user using a user interface (UI), e.g., local UI 121 or remote UI 129 sees that, as shown in 123, the external network media player 123 discovers the remote server 131 including item of content 133 (the discovery is shown as 203 in FIG. 2), and selects item of content 133 to be played back “incognito” as the particular stream for the local media player 109. In 205, the external network media player 123 received a request from a US, e.g., local UI 121 or remote UI 129 the externally sourced item of content 133 to streamed as the particular item of content to the local media player 109. It may be that the server 131 indicates that one or both of authentication and authorization is needed to access the item of content 133. Note, such authentication or authorization may need to take place even before the user can see that item of content 133 even exists. Optional block 207 includes the external network player 123, UI 121 and/or 129, and the external server 131 undergoing any authorization or authentication or both needed, and assuming success, player 123 requesting item of content 133 be streamed.

As an example, one mechanism for steps 203, 205, and 207 may be via a standard Web browser operating on the local UI 121. That is, the user accesses a Website and there requests that item of content 133 be streamed. Other examples include via a mobile device, and such mobile device need not necessarily be via the local network 105 to the local processing system 103, but rather can be a direct access to the server 131. However, such configuration is regarded as being included in the structure shown in FIG. 1, in that the remote device that can directly access the server 131 is then regarded as part of processing system 103, and its user interface the local user interface 121. As was stated above, the local processing system can include many processors, and a “smart” portable device such as a smart phone can be part of processing system 103, with the coupling being even via the external network 135. All such configurations and variations are possible.

To continue, as a result of successful authentication and authorization (assuming both were needed), in 209, the external network player 123 sets up the re-streamer 125 for re-streaming, including providing an indication that a foreign stream is being received, and receives the stream of item of content 133.

In 213, the re-streamer 125 receives the set-up information from the external network player 123 and when so indicated that a foreign stream is being re-received for re-streaming, re-streams the stream of item of content 133 as the particular stream for the local network media server 127.

Note that the indication that a foreign stream is being received may not be explicit, i.e., it may be implicit, and in some embodiments, may include the act of setting-up implicitly, meaning there is an indication. In other embodiments, an explicit indication, e.g., setting of a flag is used to indicate the receipt of the stream of the foreign, e.g., external item of content.

Not shown in FIG. 2 is that the local media player 109 discovers the local network media server 127, and that such server 127 can serve the particular item of content, in one embodiment as the one and only file, and requests playback of the particular item of content.

The external network media player in 223 receives the request from the local media player 109 for playback of the stream of the particular item of content. As shown in 225, unless there is an indication, e.g., an explicit indication, e.g., in the form of a flag being set from the re-streamer or from the external network media player that a foreign stream has been requested (at the local processing system 103), the local network media server 127 serves as the stream of the particular item of content the stream of the default item of content 128 to the local medial player. Thus, the default item of content 128 is consumed at the local media player 109. As shown in 227, in the case there is an indication that a foreign stream is being received for sending as the particular item of content, the local network media server 127 receives the re-streamed external stream from the re-streamer, and streams the re-streamed version of item of content 133 to the local media player 109 as the stream of the particular item of content.

The re-streaming is configured such that the re-streamed version of item of content 133 mimics the default item of content 128. However, anyone consuming the re-streamed version of item of content 133 consumes, e.g., views and hears and/or interacts with the item of content 133.

As in the case all item of content streams, the particular stream includes a wrapper that includes identifying and other information, and further includes the payload of the actual item of content. Using audiovisual item of content as an example, a item of content file for streaming include a stream property object, e.g., one or more headers that describe the stream properties, a more information object, e.g., one or more additional headers for other information, data packets for the video of the item of content, and data packets for the audio of the item of content.

In one embodiment, the re-streaming by the re-streamer creates a stream whose video data packets and audio data packets are of the requested item of content 133, while the stream property object and the more information object are created so that the stream appears to the local media player 109 to be a stream of the default item of content 128. When played back on the local media player 109, the rendering (the playback) is of the requested item of content 133.

The indication that a foreign stream is being received can take many forms. In one embodiment, the external network media player, and re-streamer, and the local network media server are implemented by modules of instructions executing on or more processors of the local processing system 103, and a flag accessible to each of the modules. In alternate embodiments, the re-streamer always outputs, and what it outputs depends on whether foreign, e.g., external item of content has been successfully requested for being served.

Using audiovisual item of content as an example, a file of an item of content for streaming include a stream property object, e.g., one or more headers that describe the stream properties, optionally a more information object, e.g., one or more additional headers for other information, data packets for the video of the item of content, and data packets for the audio of the item of content, the data packets of the video and the data content of the audio in general called content packets. In one embodiment, the re-streaming by the re-streamer creates a stream whose video data packets and audio data packets (in general “content” packets) are of the requested item of content 133, while the stream property object and the more information object are created so that the stream appear to the local media player 129 to be a stream of the default item of content 128. When played back on the local media player 109, the rendering (the playback) is of the requested item of content 133.

If the stream of the default item of content 128 is in a first coded format, e.g., the content packets, e.g., the audio and video packets are compressed according to a first audio compression method and a first video compression method, and the stream of the requested foreign, e.g., external item of content 133 is in another coded format, e.g., the audio and video compressed according to a second audio compression method and a second video compression method, respectively, the re-streamer 125 includes one or more transcoders configured to compress from the compression method or methods of stream of the requested item of content 133 to the compression method or methods of stream of the default item of content 128 to mimic stream of the default item of content 128.

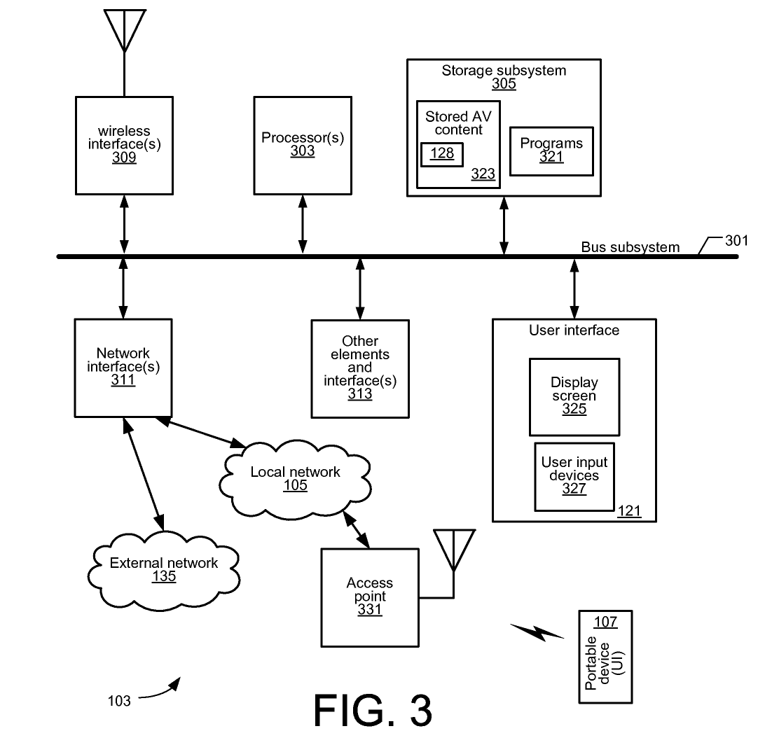

FIG. 3 shows a highly simplified block diagram of an example of the processing system 103 that includes aspects of the present invention. The processing system 103 that includes one or more processors 303. Each processor may include one or more of a CPU or similar element, a graphics processing unit (GPU), and/or a programmable DSP unit. The processing system further includes a storage subsystem 305 with at least one storage medium, which may include memory, e.g., embedded in a semiconductor device, or a separate memory subsystem including main random access memory (RAM) which may include one or more of dynamic RAM, static RAM, and ROM, and also cache memory. The storage subsystem may further include one or more other storage devices, such as magnetic and/or optical and/or further solid state storage devices, e.g., one or more hard disk drives, and a DVD reader/writer. one or more other removable storage elements may be included. The term storage device, storage subsystem, or memory unit as used herein, if clear from the context and unless explicitly stated otherwise.

The storage subsystem 305 includes programs 321 that comprise instructions that when executed cause the functionality of one or more features of the present invention to be carried out, e.g., the functionality of the external network media player 123, the re-streamer 125, and the local network media server 127. Programs 321 also includes instructions that when executed carry out streaming, and furthermore, other functions carried out by the processing system 103. The storage subsystem 305 further includes stored item of content 323, including for example, the default item of content 128.

A bus subsystem 301 is included for communicating between the components, and for simplicity, is shown as a single bus in FIG. 3, although those of skill in the art recognize that bus subsystems are typically more complicated. The processing system further includes a local user interface 121 which in the example shown includes a display screen 325, e.g., a liquid crystal display (LCD), organic light emitting display (OLED), or a cathode ray tube (CRT) display. The user interface further includes one or more user input devices 327, such as one or more of an alphanumeric input unit such as a keyboard, a pointing control device such as a mouse, and so forth.

The processing system 103 further may be a distributed processing system with processors coupled by a network, e.g., via network interface devices or wireless network interface devices. The example processing system of FIG. 3 includes at least one wireless interface 309. Also shown are one or more network interfaces 311 that may include routers and or switches, an interface to the external network 135, e.g., to the Internet, and an interface to the local network 105, e.g., via a switch in 311. In this example, a wireless LAN access point 331 is shown coupled to the local network 105 and extends the local network to include an infrastructure wireless network. A portable device with a user interface 107 is shown as wirelessly associated with the access point 331, and thus able to issue commands to the processing system 103, e.g., to the external network media player 123 as described herein. The processing system in some configurations may include a sound output device. All such other elements and interfaces are shown as 313. Of course, those skilled in the art would understand that FIG. 3 is highly simplified, and does not show many details.

Note that while simple playback of item of content is shown, those of ordinary skill in the art may modify what is described herein to include such elements as local storage of the foreign, e.g., external item of content 133 for later playback, that is, to include some form of video recorder functionality. Also, remote programming for later storage and on-demand playback also is possible.

The invention is not limited to any particular format for the item of content or of streaming. In the case of audio and video, the video part of any item of content may be encoded according to any encoding form, e.g., according to an MPEG-x format, e.g., MPEG-1, MPEG-2, or MPEG-4, Windows Media Video (WMV) or VC-1 format, MPEG-x format (e.g., MPEG-1, MPEG-2, or MPEG-4), ITU-T H.26x format (e.g., H.261, H.262, H.263, or H.264), Adobe Flash format, Windows Media Video (WMV), VC-1 format, or any other format. The audio part of any item of content may be encoded according to one or more encoding methods, such as MP3, AAC, AAC+, AC-3, E-AC-3, MP3, WMA, FLAC, or some other format.

Note that while in the above description, the foreign item of content is streamed from an external server, the invention is not limited to this architecture. The “foreign” item of content may only be “external” in that it is not the item normally served by the local network media server, e.g., not the default item of content. Furthermore, the term “foreign” The foreign item may be, for example, an item of content that is stored on the local processing system 103. It may, for example, have been previously downloaded for later viewing, stored in using a digital video recorder (DVR) functionality, and so forth.

Not described above are some additional features that may be included in different embodiments. One such feature includes the generation of an error message if the first item of content cannot be re-streamed. Such may the case, for example, if the content packets or other aspects are encrypted or not usable because of digital rights management issues. Such details are not described herein as their inclusion is optional and how to include such features would be clear to those skilled in the art.

Note that in FIG. 1, the re-streamer is shown in the local processing system 103. As was described above, the local processing system 103 can include many processors, and a “smart” portable device such as a smart phone can be part of processing system 103. Thus, nothing in this description limits the location of different elements of the local processing system 103. For example, in some alternate embodiments, one or both the server and the re-streamer are located in the portable device.

Unless specifically stated otherwise, as apparent from the following description, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Note that when a method is described that includes several elements, e.g., several steps, no ordering of such elements, e.g., of such steps is implied, unless specifically stated.

In some embodiments, a non-transitory computer-readable storage medium is configured with, e.g., encoded with instructions, e.g., with program logic that when executed by one or more processors of a processing system such as a digital signal processing device or subsystem that includes at least one processor element and a storage subsystem, cause carrying out a method as described herein. A non-transitory computer-readable medium is any computer-readable medium that is not specifically a transitory propagated signal or a transitory carrier wave or some other transitory transmission medium. Thus, a non-transitory computer-readable medium includes any tangible computer-readable storage medium.

The methodologies described herein are, in some embodiments, performable by one or more processors that accept logic, e.g., instructions encoded on one or more computer-readable storage media. Any processor capable of executing a set of instructions (sequential or otherwise) that specify actions to be taken are included. Thus, one example is a typical processing system that includes one or more processors. Each processor may include one or more of a CPU or similar element, a graphics processing unit (GPU), and/or a programmable DSP unit. The processing system further includes a storage subsystem with at least one storage medium, which may include memory embedded in a semiconductor device, or a separate memory subsystem including main RAM and/or a static RAM, and/or ROM, and also cache memory. The storage subsystem may further include one or more other storage devices, such as magnetic and/or optical and/or further solid state storage devices. A bus subsystem may be included for communicating between the components. The processing system further may be a distributed processing system with processors coupled by a network, e.g., via network interface devices or wireless network interface devices. If the processing system requires a display, such a display may be included, e.g., a liquid crystal display (LCD), organic light emitting display (OLED), or a cathode ray tube (CRT) display. If manual data entry is required, the processing system also includes an input device such as one or more of an alphanumeric input unit such as a keyboard, a pointing control device such as a mouse, and so forth. The term storage device, storage subsystem, or memory unit as used herein, if clear from the context and unless explicitly stated otherwise, also encompasses a storage system such as a disk drive unit. The processing system in some configurations may include a sound output device, and a network interface device.

The storage subsystem thus includes a non-transitory computer-readable storage medium that is configured with, e.g., encoded with, e.g., has stored therein instructions, e.g., logic, e.g., software that when executed by one or more processors, causes carrying out one of more of the method steps described herein. In the case that the storage subsystem includes several storage elements, such as a hard disk and/or one or more memory elements, and/or an optical storage medium, the software may reside in the hard disk, or may also reside, completely or at least partially, within one or more memory elements during execution thereof by the computer system.

Furthermore, a computer-readable medium may form a computer program product, or be included in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The term processing system encompasses all such possibilities, unless explicitly excluded herein. The one or more processors may form a personal computer (PC), a media playback device, a tablet PC, a set-top box (STB), a Personal Digital Assistant (PDA), a game machine, a cellular telephone, a Web appliance, a network router, switch or bridge, or any machine capable of executing a set of instructions (sequential or otherwise) that specify actions to be taken by that machine.

Note that while some diagram(s) only show(s) a single processor and a single storage subsystem, e.g., a single memory that stores the logic including instructions, those skilled in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Some embodiments are in the form of the logic itself. Thus, as will be appreciated by those skilled in the art, embodiments of the present invention may be embodied as one or more of (i) a method, (ii) an apparatus such as a special purpose apparatus, (iii) an apparatus such as a data processing system that is configured to carry out the functions described herein, (iv) a data processing system that is programmable and includes a storage subsystem in which are encoded instructions that when executed case carrying out the functions described herein, (v) a computer-readable storage medium that is encoded with instructions, e.g., a computer-readable storage medium configured with a set of instructions that when executed by one or more processors cause carrying out method steps. Accordingly, aspects of the present invention may take the form of a method, an entirely hardware embodiment, an entirely software embodiment or an embodiment combining software and hardware aspects. Furthermore, the present invention may take the form of program logic, e.g., in a computer readable medium, e.g., a computer program on a computer-readable storage medium, or the computer readable medium configured with computer-readable program code, e.g., a computer program product.

While the computer-readable storage medium is shown in an example embodiment to be a single medium, the term “medium” should be taken to include a single medium or multiple media (e.g., several memories, a centralized or distributed database, and/or associated caches and servers) that store the one or more sets of instructions. A non-transitory computer-readable medium may take many forms, including but not limited to non-volatile media and volatile media. Non-volatile media includes, for example, optical, magnetic disks, and magneto-optical disks. Volatile media includes dynamic memory, such as main memory.

It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill skilled in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the DESCRIPTION OF EXAMPLE EMBODIMENTS are hereby expressly incorporated into this DESCRIPTION OF EXAMPLE EMBODIMENTS, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All U.S. patents, U.S. patent applications, and International (PCT) patent applications designating the United States cited herein are hereby incorporated by reference. In the case the Patent Rules or Statutes do not permit incorporation by reference of material that itself incorporates information by reference, the incorporation by reference of the material herein excludes any information incorporated by reference in such incorporated by reference material, unless such information is explicitly incorporated herein by reference.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting of only elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. A method of operating a processing system, the method comprising:
as a result of a request for a stream of a first item of content, receiving the stream of the first item of content and providing an indication that a foreign stream is being received;
unless there is an indication that a foreign stream is being received, streaming a default item of content to a local media player; and
in the case there is an indication that a foreign stream is being received, re-streaming the received stream of the first item of content, such that local media player renders the requested stream of the first item of content.

2. A method as recited in claim 1, wherein the indication that a foreign stream is being received is implicit.

3. A method as recited in claim 1, wherein the providing the indication that a foreign stream is being received is explicit and includes a settable flag being set.

4. A method as recited in claim 1, wherein the first item of content is streamed by a server that is coupled to the processing system by a network.

5. A method as recited in claim 1, wherein the re-streaming of the first item of content outputs a stream that mimics the default item of content, and includes the content of the first item of content.

6. A method as recited in claim 1, wherein each of the stream of the first item of content and the stream of the default item of content includes a respective stream property object, optionally a respective more information object, and respective content packets, and wherein the re-streaming creates a stream whose content packets render the same content as the stream of the first item of content, and the stream property object and the more information object are created such that the re-streamed stream appears to the local media player to be a stream of the default item of content, even though when rendered on the local media player, the rendering is of the first item of content.

7. A method as recited in claim 1,
wherein the content stream of the first item of content is in a first coded format and the stream of the default item of content is in a second different coded format, and
wherein the re-streaming includes transcoding from the first format to the second coded format.

8. A method as recited in claim 1, wherein the receiving as a result of the request is from a server via an external network to which the processing system is coupled.

9. A method as recited in claim 8, wherein via the external network includes via the Internet.

10. A method as recited in claim 1, wherein the receiving a result of the request is from a storage subsystem included in the processing system.

11. A method as recited in claim 1, further comprising receiving the request from a user interface.

12. A method as recited in claim 1, further comprising as a result of receiving the request undergoing one or both authorization and authentication such that the receiving of the stream of the first item of content is only after success of the one or both of authorization and authentication.

13. A data processing apparatus comprising:
an external network media player coupled to a first source of content, the first source of content including a first item of content, the external network media player configured as a result of receiving a request from a user interface to receive a stream of the first item of content from the first source of content;
an re-streamer coupled to the external network media player and configured to receive a stream of a first item of content from the external network media player and re-stream the first item of content to a second stream of a second item of content that includes the content of the stream of the first item of content;
a local network media server coupled to the re-streamer and configured in the case that there is not an indication that a foreign stream is being received to stream a default item of content to a local media player, and in the case there is an indication that a foreign stream is being received, to accept the second stream of the second item of content,
such that in the case there is the indication that a foreign stream is being received, the second stream is streamed to the local server, the second stream including the content of the stream of the first item of content.

14. A data processing apparatus as recited in claim 13, wherein the indication that a foreign stream is being received is implicit.

15. A data processing apparatus as recited in claim 13, wherein the indication that a foreign stream is being received is explicit in the form of a settable flag.

16. A data processing apparatus as recited in claim 13, wherein the re-streaming of the first item of content by the re-streamer outputs a stream that mimics the default item of content, and includes the content of the first item of content.

17. A data processing apparatus as recited in claim 13, wherein each of the stream of the first item of content and the stream of the default item of content includes a respective stream property object, optionally a respective more information object, and respective content packets, and wherein the re-streamer creates a stream whose content packets render the same content as the stream of the first item of content, and the stream property object and the more information object are created such that the re-streamed stream appears to the local media player to be a stream of the default item of content, even though when rendered on the local media player, the rendering is of the first item of content.

18. A data processing apparatus as recited in claim 13,
wherein the content stream of the first item of content is in a first coded format and the stream of the default item of content is in a second different coded format, and
wherein the re-streamer includes a transcoder configured to transcode from the first format to the second coded format.

19. A data processing apparatus as recited in claim 13, further comprising a network interface configured to couple the data processing apparatus to an external network to which a server is coupled, the server storing the first item of content, and wherein the receiving as a result of the request is from the server via the external network to which the data processing apparatus is coupled.

20. A data processing apparatus as recited in claim 19, wherein via the external network includes via the Internet.

21. A data processing apparatus as recited in claim 13, further comprising a storage subsystem, the first item of content being stored in the storage subsystem.

22. A data processing apparatus as recited in claim 13, further comprising a local user interface wherefrom the request for the first item of content is received.

23. A data processing apparatus as recited in claim 13, further comprising a network interface configured to couple the data processing apparatus to an external network to which a server is coupled, the server storing the first item of content,
wherein the external media player as a result of receiving the request is configured to undergo one or both authorization and authentication with the server, such that the receiving of the stream of the first item of content is only after success of the one or both of authorization and authentication; and
wherein the receiving as a result of the request and the success of the one or both of authorization and authentication is from the server via the external network to which the data processing apparatus is coupled.

24. A tangible computer-readable storage medium configured with instruction that when executed by one or more processors of a operating a processing system, cause processing hardware to carry a method comprising:
as a result of a request for a stream of a first item of content, receiving the stream of the first item of content and providing an indication that a foreign stream is being received;
unless there is an indication that a foreign stream is being received, streaming a default item of content to a local media player; and
in the case there is an indication that a foreign stream is being received, re-streaming the received stream of the first item of content,
such that local media player renders the requested stream of the first item of content.

25. A tangible computer-readable storage medium as recited in claim 24, wherein the indication that a foreign stream is being received is implicit.

26. A tangible computer-readable storage medium as recited in claim 24, wherein the providing the indication that a foreign stream is being received is explicit and includes a settable flag being set.

27. A tangible computer-readable storage medium as recited in claim 24, wherein the first item of content is streamed by a server that is coupled to the processing system by a network.

28. A tangible computer-readable storage medium as recited in claim 24, wherein the re-streaming of the first item of content outputs a stream that mimics the default item of content, and includes the content of the first item of content.

29. A tangible computer-readable storage medium as recited in claim 24, wherein each of the stream of the first item of content and the stream of the default item of content includes a respective stream property object, optionally a respective more information object, and respective content packets, and wherein the re-streaming creates a stream whose content packets render the same content as the stream of the first item of content, and the stream property object and the more information object are created such that the re-streamed stream appears to the local media player to be a stream of the default item of content, even though when rendered on the local media player, the rendering is of the first item of content.

30. A tangible computer-readable storage medium as recited in claim 24,
wherein the content stream of the first item of content is in a first coded format and the stream of the default item of content is in a second different coded format, and
wherein the re-streaming includes transcoding from the first format to the second coded format.

31. A tangible computer-readable storage medium as recited in claim 24, wherein the receiving as a result of the request is from a server via an external network to which the processing system is coupled.

32. A tangible computer-readable storage medium as recited in claim 31, wherein via the external network includes via the Internet.

33. A tangible computer-readable storage medium as recited in claim 24, wherein the receiving a result of the request is from a storage subsystem included in the processing system.

34. A tangible computer-readable storage medium as recited in claim 24, wherein the method further comprises receiving the request from a user interface.

35. A tangible computer-readable storage medium as recited in claim 24, wherein the method further comprises as a result of receiving the request undergoing one or both authorization and authentication such that the receiving of the stream of the first item of content is only after success of the one or both of authorization and authentication.
